(19) United States
(12) Patent Application Publication
(10) Pub. No.: US 2006/0167884 A1
(43) Pub. Date: Jul. 27, 2006

(54) Method and apparatus for recording a transfer of a piece of data

(76) Inventor: Rafi (Ralph) W. Sabel, Eveleigh, New South Wales (AU)

Correspondence Address: LADAS & PARRY LLP, 224 SOUTH MICHIGAN AVENUE, SUITE 1600, CHICAGO, IL, 60604, US

(21) Appl. No.: 10/532,474

(22) PCT Filed: Oct. 24, 2003
(86) PCT No.: PCT/AU03/01418

§ 371 Date: Aug. 25, 2005

(30) Foreign Application Priority Data
Oct. 24, 2002 (AU) 2002952274

(51) Int. Cl. G06F 17/30; G06F 7/00

(52) U.S. Cl. 707/10

(57) ABSTRACT

A method of recording a transfer of a piece of data, the method comprising the steps of: determining whether a database contains a record that has data which represents the piece of data; and upon determining that the database contains the reconsetting one or more counters, which represent a total amount of the data in the record that has been transferred, such that the amount includes a quantity of the piece of data, to thereby record the transfer of the data.

### FIELD OF THE INVENTION

The present invention relates generally to a method and apparatus for recording a transfer of data. The method and apparatus of the present invention have particular, but by no means exclusive, application to recording data transferred between electronic devices via a communications network.

### BACKGROUND OF THE INVENTION

Recording data exchanged between electronic devices is desirable for several reasons. For instance, in the situation where the data being recorded includes data packets being transferred over a communications network, the record can be used to provide network administrators with an insight into the characteristics of the packets being transferred over their network. One such characteristic that network administrators are commonly interested in is destination and source addresses contained in packets. The address information assists network administrators in identifying potential points of congestion in their network, and as such allows the network administrator to re-configure their network to better handle the congestion.

Existing tools for recording data exchanged between electronic devices commonly create a record in the form of a flat file. In the above example of data packets being transferred over a communications network, the record maintained by existing tools would create a new record for each packet exchanged over the network. Unfortunately, a new record for each piece of information (packet) has the potential to generate a very large number of records, which would require significant storage space in a database.

### SUMMARY OF THE INVENTION

According to a first aspect of the present invention, there is provided a method of recording a transfer of a piece of data, the method comprising the steps of:

determining whether a database contains a record that has data which represents the piece of data; and

upon determining that the database contains the record, setting one or more counters, each of which represent a total amount of the data field that has been transferred, such that the amount includes a quantity of the data, thereby recording the transfer of the piece of data.

Thus, the method has a significant advantage over existing methods for recording the transfer of data. The significant advantage is that a new record is not created in the database for each piece of data transferred. The advantage is the result of the method setting the one or more counters fields to represent the amount of the data field that has been transferred, which effectively alleviates the need to create a new record for the data because an existing record in the database is being used to record the transfer.

Preferably, the method further comprises the step of setting the data in the record to correspond with an indicator that has a byte count less than a second byte count of the piece of data. This can effectively be thought of as normalising the record and has the advantage of reducing the amount of storage required to store the record. It also enables long-term storage of historical data and consequently enables trend analyses for capacity planning and granularity for other critical requirements.

Preferably, the step of determining whether the database contains the record comprises the steps of:

obtaining a first storage location in the database using a hash function f(K), wherein K is the piece of data; and

checking whether the record is at the first storage location.

Thus, by virtue of the hash function it is possible to quickly check for the record in the database.

Preferably, the step of setting the one or more counters comprises the steps of:

adding to a first of the counters a quantity of bytes of the piece of data; and

incrementing a second of the counters by a number of data packets associated with the piece of data.

Thus, the first and second of the counters enable the number of bytes and packets to be quickly ascertained. It is in fact the number of bytes and packets that enable the amount of data that has been transferred to be determined and numbered.

Preferably, the method further comprises the step of creating the record in the database upon determining that the database does not contain the record. This ensures that any future data transferred over the network that corresponds with the piece of data can be efficiently recorded.

Preferably, step of creating the record comprises the steps of:

obtaining a second storage location in the database using the hash function f(K), wherein K is the piece of data; and

storing the record at the second storage location.

Thus, storing the record at the second location means that the record can be relatively quickly retrieved from the database by using the hash function f(K) to obtain the second location.

Preferably, the method further comprises the step of selecting the piece of data from other data.

Thus, by being able to select the piece of data from other data means that a user can record only that data which is of interest.

Preferably, the selecting step comprises selecting the piece of data based on whether a temporal parameter associated therewith meets a predefined criterion.

Preferably, the predefined criterion comprises the temporal parameter having a value that is within a range of temporal values.

Preferably, the method further comprising the step of setting a temporal field of the record based on the temporal parameter.

Preferably, the temporal parameter comprises a time and/or date stamp.

Preferably, the piece of data is data that has been transferred over a network.

According to a second aspect of the present invention, there is provided computer software which provides instructions that enable a computer to carry out the method according to the first aspect of the present invention.

According to a third aspect of the present invention, there is a computer readable medium comprising the software according to the second aspect of the present invention.

According to a fourth aspect of the present invention, there is provided an apparatus for recording a transfer of a piece of data, the apparatus comprising:

determining means arranged to determine whether a database contains a record that has data which represents to the piece of data; and

setting means arranged to set, upon determining that the database contains the record, one or more counters, which represent a total amount of the in the record data that has been transferred, such that the amount includes a quantity of the data, thereby recording the transfer of the piece of data.

Preferably, the setting means is further arranged to set the data in the record to correspond with an indicator that has a first byte count that is less than a second byte count of the piece of data.

Preferably, the determining means is arranged to determine whether the database contains the record by:

obtaining a first storage location in the database using a hash function f(K), wherein K is the piece of data; and

checking whether the record is at the first storage location.

Preferably, the setting means is arranged to set the one or more counters by adding to a first of the counters a quantity of bytes of the piece of data, and incrementing a second of the counters a number of data packets associated with the piece of data.

Preferably, the apparatus further comprises creating means arranged to create the record in the database upon the determining means determining that the database does not contain the record.

Preferably, the creating means is arranged to create the record by:

obtaining a second storage location in the database using the hash function f(K), wherein K is the piece of data; and

storing the record at the second storage location.

Preferably, the apparatus further comprises selecting means arranged to select the piece of data from other data.

Preferably, the selecting means is arranged to select the piece of data based on whether a temporal parameter associated therewith meets a predefined criterion.

Preferably, the predefined criterion comprises the temporal parameter having a value that is within a range of temporal values.

Preferably, the setting means is arranged to set a temporal field of the record based on the temporal parameter.

Preferably, the temporal parameter comprises a time and/or date stamp.

Preferably, the piece of data is data that has been transferred over a network.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 illustrates an arrangement of a computer system that comprises an apparatus in accordance with an embodiment of the present invention;

FIG. 2 shows information created by an apparatus in the computer system of FIG. 1; and

FIG. 3 lists the various identifiers used in the fields of the information shown in FIG. 2.

### AN EMBODIMENT OF THE INVENTION

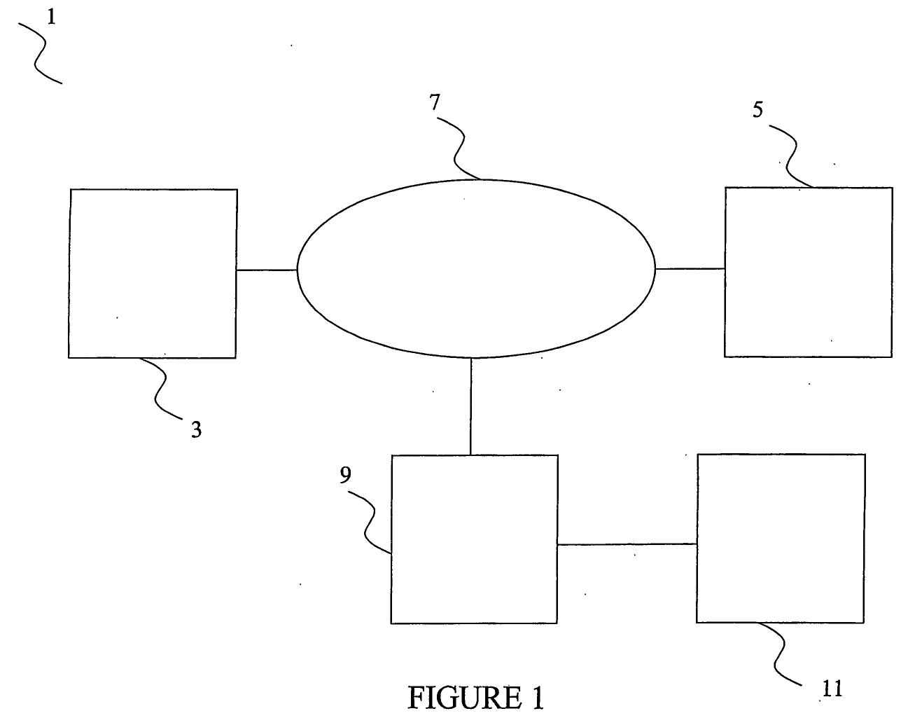

FIG. 1 illustrates a computer system 1 that comprises a first electronic device 3 and a second electronic device 5 that are interconnected to each other via a communication network 7. The electronic devices 3 and 5 are in the form of computer equipment such as a personal computer or web server. The electronic devices 5 essentially use the communication network 7 to exchange pieces of data between each other, or any other electronic devices that may be connected to the communication network 7. The communication network 7 is in the form of an IP packet switched local area network such as those commonly used in office environments.

Also attached to the communications network 7 is an apparatus 9 that is arranged to record data that is transferred between the electronic devices 3 and 5 via the network 7. The computer system 1 also comprises a relational database 11 that is connected to the apparatus 9. As outlined later in this document, the apparatus 9 uses the database 11 to record the fact that the pieces of data have been transferred over the communication network 7.

The apparatus 9 comprises determining means and setting means in the form of computer hardware and software that cooperate with each other in order to enable the apparatus 9 to record the transfer of a piece of data between the electronic devices 3 and 5 via the network. The computer hardware of the apparatus 9 is essentially the same type of hardware that is used in personal computers. In addition to hardware such as a motherboard and hard disk, the hardware of the apparatus 9 also comprises the necessary hardware to enable the apparatus 9 to be connected to the communication network 7; for example, a network interface.

The software used in the apparatus 9 comprises operating system software such as Microsoft Windows NT or UNIX, and software which specifically enables the apparatus 9 to record the piece of data transferred between the electronic devices 3 and 5 via the communication network 7. The latter software can be developed using a variety of programming languages including, for example, JAVA or C++.

As mentioned previously, the communication network 7 is in the form of an IP packet switched network consequently, the data exchanged between the electronic devices 3 and 5 is in the form of IP packets.

The apparatus 9 is such that when the electronic devices 3 and 5 transfer pieces of data (IP packets) via the communication network 7, the apparatus 9 obtains a copy of the data by ‘sniffing’ the network 7. Persons skilled in the art will appreciate that other means for collecting the data can be employed, such as reading raw text logs or text streams output from some other packet collector. Upon obtaining the data, the apparatus 9 creates information that is representative of the data sent over the network 7 (a TCP/IP packet). The information has a structure that conforms to a predetermined format. The apparatus 9 encodes the information using ASCII. The apparatus 9 stores the information as a text file in a storage device, which is typically in memory or on a hard disk.

During the process of creating the information, the apparatus 9 may normalise the data. Basically, normalising the data involves replacing the actual data in the record with other data which has a lower byte count than the actual data transferred over the network. The advantage of this is that it further reduces the amount of space required to store the record. For example, rather than storing the actual data correspond to an IP address, which may require 15 bytes of data, the IP address might be represented by the number “1”, for instance, which would only need 1 byte of information. Of course, this technique would require the use of a look-up table which would enable the “1” to be resolved into the actual IP address.

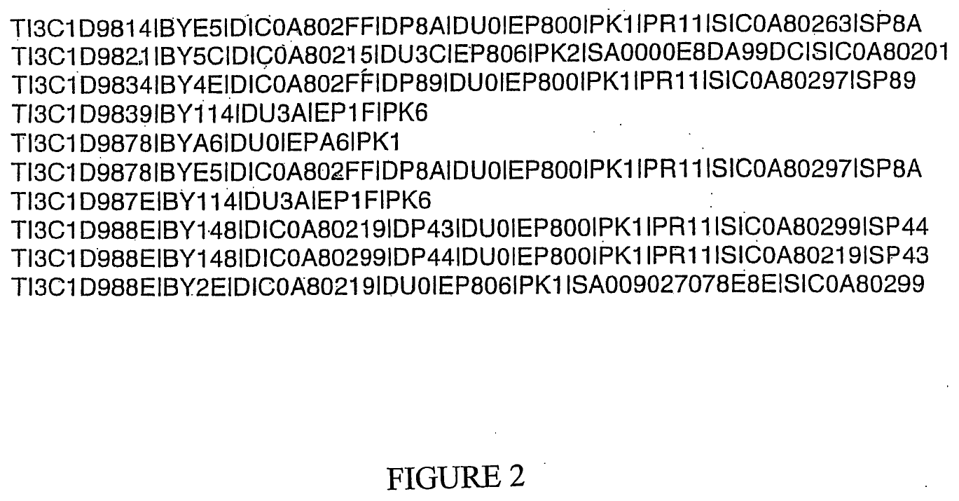

The structure of the information can be seen in FIG. 2. With reference to FIG. 2, the structure of the information is such that each row thereof comprises a plurality of fields which are defined by the “|” character. A number of the fields in each row of the information correspond with fields in the data transferred of the network 7. For example, given that the data is transferred in IP packets, the fields could correspond with, for example, destination and source address fields in the IP packets. The information also contains fields that do not correspond with fields in the IP packets. For instance, each row of the information contains a field that contains a time stamp, and a field that represents the amount of data that has been transferred over the network 7 on the corresponding IP packet. The fields of the information fall generally into one of four groups. The four groups comprise timestamp fields, structural fields, key fields, and counter fields. The key fields group comprises a sub-group referred to as secondary key fields.

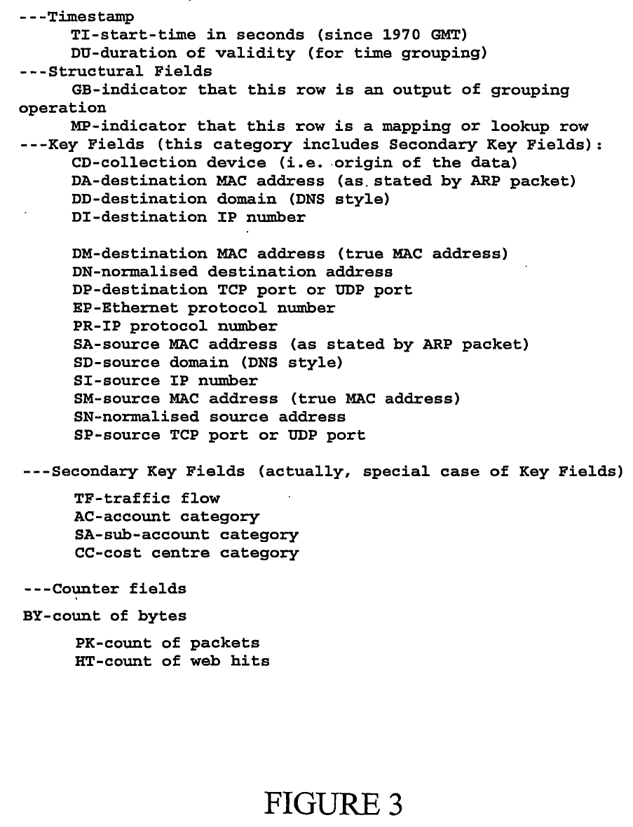

Each field in the information starts with an identifier in the form of two letters from the English alphabet. The identifier allows the type of data in the respective field to be identified. For example, “DI” is used to indicate that the field relates to a destination IP address, and “SI” indicates that a field relates to a source IP address. A list of the identifiers commonly used is shown in FIG. 3. Each row of information in FIG. 2 represents one or more IP packets. Thus, the total number of rows in the information corresponds to the total number of packets ‘supplied’ by the apparatus 9.

During the process of creating the information shown in FIG. 2, the apparatus 9 sets several fields of the information to an initial value. The several fields comprise the “TI”, “BY”, and “PK” fields. The “TI” field is timestamped with a time that substantially reflects the time the corresponding IP packet was ‘sniffed’ by the apparatus 9. The “BY” field is set to the number of bytes in the data, and the “PK” is set to I because it represents one or more packets. The other fields are set according to the corresponding information in the fields of the respective IP packet. For example, the “DI” field of the information is set to represent the destination IP address contained in the relevant IP packet.

The apparatus 9 is arranged to continuously ‘sniff’ the computer network 7, and consequently the number of rows in the information shown in FIG. 2 increases as more IP packets are sent over the communication network 7. Once the information created by the apparatus 9 reaches a certain size, for example 100 rows, the apparatus 9 selects those rows that have a “TI” field (timestamp) that meets a predefined criterion. In the case of the present embodiment, the predefined criterion is that the “TI” field falls within the bounds of a particular period of time. For example, where the particular period of time is 3.00 am to 4.00 am, then the apparatus will only select those rows in the information (shown in FIG. 2) that have a “TI” field that is greater than 3.00 am and less than 4.00 am. It will be appreciated that other periods of time could be used, for example, a period of 1 minute.

The apparatus 9 then proceeds to extract one or more key fields from each of the rows selected from the information. For each of the extracted key fields, the determining means of the apparatus 9 interrogates the database 11 to determine whether it contains a record that has data which corresponds with the extracted key field being processed. In order to improve the performance of the database 11, the records in the database 11 are stored in a hash table. Consequently, in order to determine whether the record exists, the determining means of the apparatus 9 is arranged to obtain a first storage location in the database using a hash function f(K), where K is one of the extracted key field of interest. On obtaining the first storage location, the determining means of the apparatus 9 issues a request to the database 9 to retrieve the record from the first storage location. If the record retrieved from the first storage location has data that corresponds with an extracted key field K, the apparatus 9 proceeds to take the necessary steps to set one or more counters of the record that are at the first storage location.

In setting the counters of the record, the setting means of the apparatus 9 sets them to represent a total amount of the piece of data that has been transferred. It is noted that the total amount is set to a value that takes in to account the quantity of the data contained in the relevant extracted key field. More specifically, the setting means of the apparatus 9 adds to a first of the counters the number of bytes in the extracted data field, and increments a second of the counters to represent that a further packet (which in this case is an IP packet) has been sent over the communication network 7. It is the action of setting the counters that effectively records the transfer of pieces of data over the communication network 7. As mentioned previously, the counters effectively represent the amount of the data that has been transferred over the network.

If, however, the record at the first storage location does not contain data that corresponds with the extracted key field K, the apparatus 9 has creating means which is arranged to interact with the database 11 in order to create a record therein which has data that corresponds to the extracted key field K. In order to create the record, the creation means, which is in the form of software and hardware, of the apparatus 9 is arranged to obtain a second storage location using the hash function f(K), where K is the extracted key field. The creation means of the apparatus 9 then interacts with the database 11 to store the record at the second location therein.

The database 11 is arranged such that it is capable of normalising itself. As persons skilled in the art will appreciate, normalising the database 11 provides a level of protection against corruption of the database 11.

The creating means of the apparatus 9 sets the counters of the record to represent a total amount of the data in the record that has been transferred over the communication network 7. The total amount includes the quantity of the data that is contained in the relevant key field extracted from the selected rows of information created by the apparatus 9.

The database 11 is such that the entity can access the records contained therein. Typically, the access would be made by a computer that is arranged to retrieve the records from the database 11 and process them to be presented to an administrator of the network 7, or alternatively a technical and business audience. The entity would typically present the records from the database 11 via a graphical interface to allow the administrator to study the traffic on the network 7. It will be appreciated that other techniques could be used to present the information, such as a CSV output, XML, SNMP trap or email.

Tests have shown that the embodiment of the present invention required storage space in the database which is on average 0.1% of original data volume, and requires approximately 15-30 GB of hard disk storage over 12 months for a 3000-5000 user network.

The following is a formal description of the main steps that are performed by the apparatus in order to record a transfer of data.

INP_LIST//input list of rows whose “TI” fields that meet predefined criteria

HASH//hash table

For each INP//for each row from INP_LIST INP.KEYS//Key fields extracted from INP INP.COUNTERS//Counter fields extracted R//A row returned from look-up of

HASH (INP.KEYS)
If no R then make new R as follows
   R.KEYS=INP.KEYS
   R.COUNTERS=all set to 0
   R.TI=INP.TI
   R.DU=INP.DU
Else update R as follows
   R.COUNTERS+=INP.COUNTERS
   R.DU=max(R.TI+R.DU, INP.TI+INP.DU)−

R.TI, where R.TI=min(R.TI, INP.ti) Endif

R is inserted in to HASH(R.KEYS)

Continue for all rows in INP_LIST

A worked example of the above formal algorithm is provided below. It is noted that the example is based on the information shown in FIG. 2. The information is however reiterated at the start of the worked example.

Raw Input Lines (information shown in FIG. 2):
TI3C1D9814|BYE5⊕DICOA802FF|DP8A|DUO|EP800|PK1|PR11|SICOA80263|SP8A
TI3C1D9821|BY5|DICOA80215|DU3C|EP806|PK2|SAOOOOE8DA99DC|SICOA80201
TI3C1D9834|BY4E|DICOA802F|DP89|DUO|EP800|PK1|PR11|SIOA80297|SP89
TI3C1D9839|BY114|DU3A|EP1F|PK6
TI3C1D9878|BYA6|DUO|EPA6|PK1
TI3C1D9878|BYE5|DICOA802FF|DP8A|DUO|EP800|PK1|PR11|SICOA80297|SP8A
TI3C1D987E|BY114|DU3A|EP1F|PX6
TI3C1D988E|BY148|DICOA80219|DP43|DUO|EP800|PK1|PR11|SICOA80299|SP44
TI3C1D988E|BY148|DICOA80299|DP44|DUO|EP800|PK1|PR11|SICOA80219|SP43
TI3C1D988E|BY2E|DICOA80219|DUO|EP806|PK1|SA009027078E8E|SICOA80299

Group by DI|SI tags:

Remove any key tags other than DI and SI and isolate the key tags:
DICOA802FF|SICOA80263|TI3C1D9814|BYE5|DUO|PK1
UICOA80215|SICOA80201|TI3C1D9821|BY5C|DU3C|PK2
DICOA802FF|SICOA80297|TI3C1D9834|BY4E|DUO|PK1
TI3C1D9839|BY114|DU3A|PK6
TI3C1D9878|BYA6|DUO|PK1
DICOA802FF|SICOA80297|TI3C1D9878|BYE5|DUO|PK1
TI3C1D987E|BY114|DU3A|PK6
DICOA80219|SICOA80299|TI3C1D988E|BY|48|DUO|PK1
DICOA80299|SICOA80219|TI3C1D988E|BY|48|DUO|PK1
DICOA80219|SICOA80299|TI3C1D988E|BY2E|DUO|PK1

Group together the identical keys, sum counters, update TI and DU, add GB:
DICOA802FF|SICOA80263|TI3C1D9814|BYE5|DUO|PK1|GBD|SI
DICOA80215|SICOA80201|TI3C1D9821|BY5C|DU3C|PK2|GBD|SI
DICOA802FF|SICOA80297|TI3C1D9834|BY133|DU44|PK2|GBD|SI
TI3C1D9839|BY2CE|DU7F|PKD|GBD|SI
DICOA80219|SICOA80299|TI3C1D988E|BY176|DUO|PK2|GBD|SI
DICOA80299|SICOA80219|TI3C1D988E|BY148|DUO|PK1|GBD|SI

Put tags back into correct ordering:
TI3C1D9814|BYE5|DICOA802FF|DUO|GBD|SI|PK1|SICOA80263
TI3C1D9821|BY5C|DICOA80215|DU3C|GBD|SI|PK2|SICOA80201
TI3C1D9834|BY133|DICOA802FF|DU44|GBD|SI|PK2|SICOA80297
TI3C1D9839|BY2CE|DU7F|GBD|SI|PKD
TI3C1D988E|BY176|DICOA80219|DUO|GBD|SI|PK2|SICOA80299
TI3C1D988E|BY148|DICOA80299|DUO|GBD|SI|PK1|SICOA80219

Starting from the same input group by only DP|SP tags:

Remove any key tags other than DP and SP and isolate the key tags:
DP8A|SP8A|TI3C1D9814|BYE5|DUO|PK
TI3C1D9821|BY5C1DU3C|PK2
DP89|SP89|TI3C1D9834|BY4E|DUO|PK1
TI3C1D9839|BY114|DU3A|PK6
TI3C1D9878|BYA6|DUO|PK
DP8A|SP8A|TI3C1D9878|BYE5|DUO|PK
TI3C1D987E|BY114|DU3A|PK6
DP43|SP44|TI3C1D988E|BY148|DUO|PK1
DP44|SP43|TI3C1D988E|BY148|DUO|PK1
TI3C1D988E|BY2E|DUO|PK1

Group together the identical keys, sum counters, update TI and DU, add GB:
DP8A|SP8A|TI3C1D98141BY1CA|DU64|PK1|GBDPSP
TI3C1D9821|BY358|DU97|PK10|GBDPSP
DP89|SP89|TI3C1D9834|BY4E|DUO|PK1|GBDPSP
DP43|SP44|TI3C1D988E|BY148|DUO|PK1|GBDPSP
DP44|SP43|TI3C1D988E|BY148|DUO|PK1|GBDPSP

Put tags back into correct ordering:
TI3C1D814|BY1CA|DP8A|DU64|GBDPSP|PK1|SP8A
TI3C1D821|BY358|DU97|GBDPSP|PK10
TI3C1D834|BY4E|DP89|DUO|GBDPSP|PK1|SP89
TI3C1D88E|BY148|DP43|DUO|GBDPSP|PK1|SP44
TI3C1D88E|BY148|DP44|DUO|GBDPSP|PK1|SP43

Full collection of raw lines plus grouped lines (sorted):
TI3C1D98141BY1CA|DP8A|DU64|GBDPSP|PK2|SP8A
TI3C1D814|BYE5|D|COA802FF|DP8A|DUO|EP800|PK1≡PR11|SICOA80263|SP8A
TI3C1D9814|BYE5|DICOA802FF|DUO|GBD|SI|PK1|SICOA80263
TI3C1D821|BY358|DU97|GBDPSP|PK10
TI3C1D821|BY5C|DICOA80215|DU3C|EP806|PK2SAOOOOE8DA99DC|SICOA80201
TI3C1D821|BY5C|DICOA80215|DU3C|GBD|S|PK2|SICOA8020|
TI3C1D834|BY133|DICOA802FF|DU44|GBD|S|PK2|SICOA80297
TI3C1D834|BY4E|DICOA802FF|DP89|DUO|EP800|PR1|PR1|SICOA80297|SP89
TI3C1D834|BY4E|DP89|DUO|GBDPSP|PX1|SP89
TI3C1D839|BY114|DU3A|EP1F|PK6
TI3C1D839|BY2CE|DU7F|GBD|SI|PKD
TI3C1D878|BYA6|DUO|EPA6|PK1
TI3C1D878|BYE5|DICOA802FF|DP8A|DUO|EP800|PK1|PR11|S|COA80297|SP8A
TI3C1D987E|BY114|DU3A|EP1F|PK6
TI3C1D987E|BY148|DICOA80219|DP43|DUO|EP800|PK1|PR11|SICOA80299|SP44
TI3C1D988E|BY148|DICOA80299|DP44|DUO|EP800|PK1|PR11|SICOA80219|SP43
TI3C1D988E|BY148|DICOA80299|DUO|GBD|SI|PK1|SICOA80219
TI3C1D988E|BY148|DP43|DUO|GBDPSP|PK1|SP44
TI3C1D988E|BY148|DP44|DUO|GBDPSP|PK11|SP43
TI3C1D988E|BY176|DICOA80219|DUO|GBD|SI|PK2|SICOA80299
TI3C1D988E|BY2E|DICOA80219|DUO|EP806|PK1|SA009027078E8E|SICOA80299

An example of records when normalising is applied is as follows:
n=Next logical number
Hin=Header Index
HDn=Header Detail line for Variable length records
DTn=Detail record pertaining to a particular Header detail line
SIn=Source IP
FDR|NL10|HI1
HI1|TI1=3C1D814
HI1|SI1=COA8020
HI1|SN1=AccountNameFromCode
HI1|SN1=AccountNameToCode
HI1|DI2=COA802FF
HI1DN2=UserNameCode
HD1|TI|BY|PK|SI|SN|DI|DN|SP|DP|PR|NH|MI|MO|TS|AS|AD|DU
DT1|HD1|1|128000|30|1|1|1|1|A0|B0|11|BBCBDBE|101|202|5|7|8|9
DT2|HD1|1|128000|30|1|1|2|2|A0|B0|11|BBCBDBE|101|202|5 |7 |8|9
DT3|HD1|1|128000|30|1|1|2|2|A0|B0|11|BBCBDBE|101|202|5|7|8|9
HD2|TI|PK|BY|SI|SN|DI|DN|SP|DP|PR|NH|MI|MO|TS|AS|AD|DU|NF
HI2|TI2=3C1D815
DT1|HD2|2|128000|30|1|1|1|1|A0|B0|11|BBCBDBE|101|202|5|7|8|9|88

It will be appreciated that whilst the embodiment of the present invention has been described in the context of recording data which is transferred between devices via a communication network, the present invention has in fact applications in other areas. For example, the present invention may well be used to record data transferred between electronic components (for example, microprocessors) via a data bus. In another applications, the present invention can be used to record stock market data.

Those skilled in the art will appreciate that the invention described herein is susceptible to variations and modifications other than those specifically described. It should be understood that the invention includes all such variations and modifications which fall within the spirit and scope of the invention.

1-26. (canceled)

27. A method of recording a transfer of a piece of data, the method comprising the steps of:
i. determining whether a database contains a record that has data which represents the piece of data; and
ii. upon determining that the database contains the record, setting one or more counters, which represent a total amount of the data in the record that has been transferred, such that the amount includes a quantity of the piece of data, to thereby record the transfer of the data.

28. The method as claimed in claim 27, further comprising the step of setting the data in the record to correspond with an indicator that has a byte count less than a byte count of the piece of data.

29. The method as claimed in claim 28, wherein the step of determining whether the database contains the record comprises the steps of:
a. obtaining a first storage location in the database using a hash function f(K), wherein K is the piece of data; and
b. checking whether the record is at the first storage location.

30. The method as claimed in claim 29, wherein the step of setting the one or more counters comprises the steps of:
a. adding to a first of the counters a quantity of bytes of the piece of data; and
b. incrementing a second of the counters by a number of data packets associated with the piece of data.

31. The method as claimed in claim 30, further comprising the step of creating the record in the database upon determining that the database does not contain the record.

32. The method as claimed in claim 31, wherein the step of creating the record comprises the steps of:
a. obtaining a second storage location in the database using the hash function f(K), wherein K is the piece of data; and
b. storing the record at the second storage location.

33. The method as claimed in claim 32, further comprising the step of selecting the piece of data from other data associated therewith.

34. The method as claimed in claim 33, wherein the selecting step comprises selecting the piece of data based on whether a temporal parameter associated therewith meets a predefined criterion.

35. The method as claimed in claim 34, wherein the predefined criterion comprises the temporal parameter having a value that is within a range of temporal values.

36. The method as claimed in claim 35, further comprising the step of setting a temporal field of the record based on the temporal parameter.

37. The method as claimed in any one of claim 36, wherein the temporal parameter comprises a time and/or date stamp.

38. Computer hardware storing software which when executed causes a computer to carry out the method as claimed in claim 27.

39. An apparatus recording a transfer of a piece of data, the system comprising:
a. determining means arranged to determine whether a database contains a record that has data which corresponds to the piece of data; and
b. setting means arranged to set, upon determining that the database contains the record, one or more counters, which represent a total amount of the data in the record that has been transferred, such that the amount includes a quantity of the piece of data to thereby record the transfer of the data.

40. A computer readable medium comprising the software claimed in claim 39.

41. The apparatus as claimed in claim 39, wherein the setting means is further arranged to set the data field to correspond with an indicator that has a first byte count less than a second byte count of the piece of data.

42. The apparatus as claimed in claim 40, wherein the determining means is arranged to determine whether the database contains the record by:
a. obtaining a first storage location in the database using a hash function f(K), wherein K is the piece of data; and
b. checking whether the record is at the first storage location.

43. The apparatus as claimed in claim 41, wherein the setting means is arranged to set the one or more counters by adding to a first of the counters a quantity of bytes of the piece of data, and incrementing a second of the counters by a number of data packets associated with the piece of data.

44. The apparatus as claimed in claim 42, further comprising creating means arranged to create the record in the database upon the determining means determining that the database does not contain the record.

45. The apparatus as claimed in claim 43, wherein the creating means is arranged to create the record by:
a. obtaining a second storage location in the database using the hash function f(K), wherein K is the piece of data; and
b. storing the record at the second storage location.

46. The apparatus as claimed in claim 44, further comprising selecting means arranged to select the piece of data from other data associated therewith.

47. The apparatus as claimed in claim 45, wherein the selecting means is arranged to select the piece of data based on whether a temporal parameter associated therewith meets a predefined criterion.

48. The apparatus as claimed in claim 46, wherein the predefined criterion comprises the temporal parameter having a value that is within a range of temporal values.

49. The apparatus as claimed in claim 47, wherein the setting means is arranged to set a temporal field of the record based on the temporal parameter.

50. The apparatus as claimed in claim 48, wherein the temporal parameter comprises a time and/or date stamp.
